(19) United States
(12) Patent Application Publication
(10) Pub. No.: US 2020/0258653 A1
(43) Pub. Date: Aug. 13, 2020

(54) COATED CARBON NANOTUBE ELECTRIC WIRE

(71) Applicant: FURUKAWA ELECTRIC CO., LTD., Tokyo (JP)

(72) Inventors: Hideki AIZAWA, Tokyo (JP); Satoshi YAMAZAKI, Tokyo (JP); Satoshi YAMASHITA, Tokyo (JP); Kenji HATAMOTO, Tokyo (JP)

(73) Assignee: FURUKAWA ELECTRIC CO., LTD., Tokyo (JP)

(21) Appl. No.: 16/859,069

(22) Filed: Apr. 27, 2020

Related U.S. Application Data
(63) Continuation of application No. PCT/JP2018/039976, filed on Oct. 26, 2018.

(30) Foreign Application Priority Data
Oct. 26, 2017 (JP) 2017-207672

(51) Int. Cl. H01B 7/00; H01B 7/42

(52) U.S. Cl. CPC H01B 7/0009; H01B 1/04; H01B 7/421

(57) ABSTRACT

The present disclosure provides a coated carbon nanotube electric wire that has excellent electroconductivity comparable to electric wires made of copper, aluminum, and the like, achieves marked weight reduction and heat dissipation characteristics, and excels in adhesiveness between an insulating coating and core wire. A coated carbon nanotube electric wire includes a carbon nanotube wire made up of one or more carbon nanotube aggregates formed by a plurality of carbon nanotubes, and an insulating coating layer configured to coat the carbon nanotube wire, in which arithmetic mean roughness (Ra1) of an outer surface of the carbon nanotube wire in a circumferential direction is larger than arithmetic mean roughness (Ra2) of an outer surface of the insulating coating layer in the circumferential direction.

### CROSS REFERENCE TO RELATED APPLICATIONS

The present application is a continuation application of International Patent Application No. PCT/JP2018/039976 filed on Oct. 26, 2018, which claims the benefit of Japanese Patent Application No. 2017-207672, filed on Oct. 26, 2017. The contents of these applications are incorporated herein by reference in their entirety.

### BACKGROUND

### Technical Field

The present disclosure relates to a coated carbon nanotube electric wire produced by coating a carbon nanotube wire formed by plural carbon nanotubes with an insulating material.

### Background

Carbon nanotubes (hereinafter sometimes referred to as “CNT”) is a material having various properties, and application to a large number of fields is expected.

For example, CNT is a three-dimensional network formed by a single layer of a tubular body having a hexagonal lattice-like network structure or a multiple layer of the tubular bodies placed substantially coaxially, and is lightweight and has excellent properties including electroconductivity, thermal conductivity, and mechanical strength. However, it is not easy to produce a wire from CNT, and few techniques using CNT as wires have been developed.

As an example of a few techniques using CNT wires, the use of CNT is being considered as a substitute for metal which is a material embedded in via holes formed in a multilayer wiring structure. Specifically, to reduce resistance of a multilayer wiring structure, a wiring structure has been proposed that uses multilayer CNT for interlayer wiring among two or more conductive layers, in which plural cut ends of the multilayer CNT extending concentrically to an end portion farther from a starting point for growth of the multilayer CNT are placed in contact with conductive layers (Japanese Patent Laid-Open No. 2006-120730).

As another example, a carbon nanotube material has been proposed, in which conductive deposits made of metal and the like are formed at electrical junctions of adjacent CNT wires to further improve the electroconductivity of CNT material, and it is disclosed that such a carbon nanotube material is widely applicable (Japanese Translation of PCT International Application Publication No. 2015-523944). Also, a heater having a heat-transferring member made of carbon nanotube matrices has been proposed because of the excellent thermal conductivity of CNT wires (Japanese Patent Laid-Open No. 2015-181102).

On the other hand, an electric wire made up of a core wire formed of one or more wires and an insulating coating configured to coat the core wire is used for power lines and signal lines in various fields including the fields of automobiles and industrial equipment. As a material for the wire forming the core wire, copper or a copper alloy is usually used from the viewpoint of electric characteristics, but aluminum or an aluminum alloys have been proposed recently from the viewpoint of weight reduction. For example, the specific gravity of aluminum is approximately ⅓ the specific gravity of copper while the electric conductivity of aluminum is approximately ⅔ the electric conductivity of copper (when the electric conductivity of pure copper is taken as 100% IACS, the electric conductivity of aluminum is 66% IACS), and thus to pass the same current through an aluminum wire as through a copper wire, it is necessary to increase the sectional area of the aluminum wire to approximately 1.5 times the sectional area of the copper wire, but even if an aluminum wire with such an increased sectional area is used, because the mass of the aluminum wire is about half the mass of the pure copper wire, it is advantageous to use the aluminum wire from the viewpoint of weight reduction.

Also, along with ongoing performance improvements and functionality enhancement of automobiles, industrial equipment, and the like, installed numbers of various electrical equipment, control equipment, and the like increase and the number of wires in electrical wiring used for the equipment and heat generation from the core wires are on the increase as well. Thus, there is a demand to improve heat dissipation characteristics of electric wires without impairing insulation property provided by insulating coating. On the other hand, in order to improve the fuel economy of moving bodies such as automobiles for environmental responses, there is demand for weight reduction of wires.

Also, carbon nanotube wires, which are more resistant to plastic deformation and breaking than metal wires, have far wider range of bending angles than the metal wires. Therefore, when an external force acts on a carbon nanotube electric wire produced by putting an insulating coating on carbon nanotubes, stresses concentrate on an interface between the insulating coating and carbon nanotube wire, and so the insulating coating tends to separate from the core wire. On the other hand, to maintain good insulation property of the electric wire for an extended period of time, it is necessary to prevent abrasion of the insulating coating and improve durability of the insulating coating as well.

The present disclosure is related to providing a coated carbon nanotube electric wire that has excellent electroconductivity comparable to electric wires made of copper, aluminum, and the like, achieves marked weight reduction and heat dissipation characteristics, and excels in adhesiveness between an insulating coating and core wire.

### SUMMARY

A first aspect of the present disclosure is a coated carbon nanotube electric wire comprising: a carbon nanotube wire made up of one or more carbon nanotube aggregates formed by a plurality of carbon nanotubes; and an insulating coating layer configured to coat the carbon nanotube wire, wherein arithmetic mean roughness (Ra1) of an outer surface of the carbon nanotube wire in a circumferential direction is larger than arithmetic mean roughness (Ra2) of an outer surface of the insulating coating layer in the circumferential direction.

A second aspect of the present disclosure is a coated carbon nanotube electric wire comprising: a carbon nanotube wire made up of one or more carbon nanotube aggregates formed by a plurality of carbon nanotubes; and an insulating coating layer configured to coat the carbon nanotube wire, wherein arithmetic mean roughness (Ra3) of an outer surface of the carbon nanotube wire in a longitudinal direction is larger than arithmetic mean roughness (Ra4) of an outer surface of the insulating coating layer in the longitudinal direction.

A third aspect of the present disclosure is a coated carbon nanotube electric wire comprising: a carbon nanotube wire made up of one or more carbon nanotube aggregates formed by a plurality of carbon nanotubes; and an insulating coating layer configured to coat the carbon nanotube wire, wherein arithmetic mean roughness (Ra1) of an outer surface of the carbon nanotube wire in a circumferential direction is larger than arithmetic mean roughness (Ra2) of an outer surface of the insulating coating layer in the circumferential direction, and arithmetic mean roughness (Ra3) of an outer surface of the carbon nanotube wire in a longitudinal direction is larger than arithmetic mean roughness (Ra4) of an outer surface of the insulating coating layer in the longitudinal direction.

According to a fourth aspect of the present disclosure, in the coated carbon nanotube electric wire, the carbon nanotube wire is formed by stranding together a plurality of the carbon nanotube aggregates.

According to a fifth aspect of the present disclosure, in the coated carbon nanotube electric wire, a twist count of the carbon nanotube wire formed by stranding is 100 T/m to 14000 T/m, both inclusive. According to a sixth aspect of the present disclosure, in the coated carbon nanotube electric wire, a twist count of the carbon nanotube wire formed by stranding is 500 T/m to 14000 T/m, both inclusive. According to a seventh aspect of the present disclosure, in the coated carbon nanotube electric wire, a twist count of the carbon nanotube wire formed by stranding is 1000 T/m to 14000 T/m, both inclusive. According to an eighth aspect of the present disclosure, in the coated carbon nanotube electric wire, a twist count of the carbon nanotube wire formed by stranding is 2500 T/m to 14000 T/m, both inclusive.

According to a ninth aspect of the present disclosure, in the coated carbon nanotube electric wire, at least part of the insulating coating layer is in contact with the carbon nanotube wire.

According to a tenth aspect of the present disclosure, in the coated carbon nanotube electric wire, arithmetic mean roughness (Ra1) of an outer surface of the carbon nanotube wire in a circumferential direction is 8.0 μm to 60.0 μm, both inclusive, and arithmetic mean roughness (Ra2) of an outer surface of the insulating coating layer in the circumferential direction is 12.0 μm or less.

According to an eleventh aspect of the present disclosure, in the coated carbon nanotube electric wire, arithmetic mean roughness (Ra3) of an outer surface of the carbon nanotube wire in a longitudinal direction is 8.0 μm to 45.0 μm, both inclusive, and arithmetic mean roughness (Ra4) of an outer surface of the insulating coating layer in the longitudinal direction is 15.0 μm or less.

According to a twelfth aspect of the present disclosure, in the coated carbon nanotube electric wire, a metal layer is provided between the carbon nanotube wire and the insulating coating layer.

According to a thirteenth aspect of the present disclosure, in the coated carbon nanotube electric wire, the carbon nanotube wire is made up of a plurality of the carbon nanotube aggregates, and a full-width at half maximum Δθ in azimuth angle in azimuth plot of small-angle X-ray scattering is 60 degrees or less, the small-angle X-ray scattering representing orientations of the plurality of carbon nanotube aggregates.

According to a fourteenth aspect of the present disclosure, in the coated carbon nanotube electric wire, a q value of a peak top at a (10) peak of scattering intensity of X-ray scattering representing density of a plurality of the carbon nanotubes is 2.0 nm⁻¹ to 5.0 nm⁻¹, both inclusive, and a full-width at half maximum Δq is 0.1 nm⁻¹ to 2.0 nm⁻¹.

A fifteenth aspect of the present disclosure is a wire harness using the coated carbon nanotube electric wire.

Unlike a core wire made of metal, a carbon nanotube wire using a carbon nanotube as a core wire shows anisotropy in thermal conductivity and conducts heat more preferentially in a longitudinal direction than in a radial direction. That is, the carbon nanotube wire, which shows anisotropy in heat dissipation characteristics, has superior heat dissipation ability compared to core wires made of metal and lends itself to weight reduction even if an insulating coating layer is formed. Also, since the arithmetic mean roughness of the outer surface of the carbon nanotube wire is larger than the arithmetic mean roughness of the outer surface of the insulating coating layer, a coated carbon nanotube electric wire that combines weight reduction, heat dissipation characteristics, and adhesiveness between the insulating coating and core wire can be obtained.

### BRIEF DESCRIPTION OF THE DRAWINGS

FIG. 1 is an explanatory diagram of a coated carbon nanotube electric wire according to an exemplary embodiment of the present disclosure;

FIG. 2 is an explanatory diagram of a carbon nanotube wire used for the coated carbon nanotube electric wire according to the exemplary embodiment of the present disclosure;

FIG. 3A is diagram showing an example of a two-dimensional scattering image of an SAXS-based scattering vector q of plural carbon nanotube aggregates, and FIG. 3B is a graph showing an example of an azimuth angle versus scattering intensity relationship of an arbitrary scattering vector q whose origin is at the position of a transmitted X-ray in a two-dimensional scattering image; and

FIG. 4 is a graph showing a q value versus intensity relationship in WAXS of plural carbon nanotubes forming a carbon nanotube aggregate.

### DETAILED DESCRIPTION

Hereinafter, a coated carbon nanotube electric wire according to an exemplary embodiment of the present disclosure will be described with reference to the accompanying drawings.

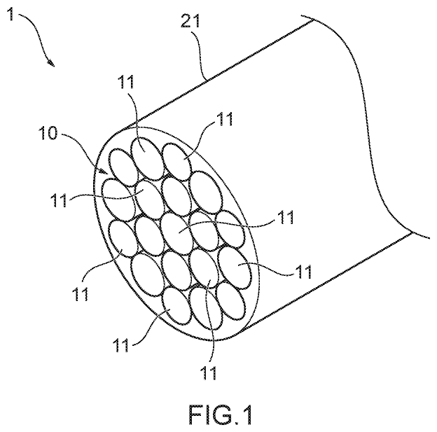

As shown in FIG. 1, the coated carbon nanotube electric wire (hereinafter sometimes referred to as a “coated CNT electric wire”) 1 according to the exemplary embodiment of the present invention is configured by coating a peripheral surface of a carbon nanotube wire (hereinafter sometimes referred to as a “CNT wire”) 10 with an insulating coating layer 21. That is, the CNT wire 10 is coated with the insulating coating layer 21 along a longitudinal direction of the CNT wire 10. In the coated CNT electric wire 1, the entire peripheral surface of the CNT wire 10 is coated with the insulating coating layer 21. Also, the coated CNT electric wire 1 is in a form in which the insulating coating layer 21 is placed in direct contact with the peripheral surface of the CNT wire 10. Whereas the CNT wire 10 is shown as being an element wire (solid wire) made up of a single wire in FIG. 1, the CNT wire 10 may be a strand wire formed by stranding together plural wires by a predetermined twist count. By implementing the CNT wire 10 in the form of a strand wire, it is possible to adjusted, as appropriate, an equivalent circle diameter and sectional area of the CNT wire 10 as well as adjust arithmetic mean roughness of an outer surface of the CNT wire 10 in a circumferential direction and the longitudinal direction.

When a strand wire is used for the CNT wire 10, the twist count is not specifically limited, but a lower limit of the twist count is preferably 100 T/m in terms of further improving heat dissipation ability, more preferably 500 T/m, still more preferably 1000 T/m, and particularly preferably 2500 T/m. On the other hand, an upper limit of the twist count when a strand wire is used for the CNT wire 10 is preferably 14000 T/m in terms of mechanical strength of the CNT wire 10, and particularly preferably 13000 T/m. Thus, in terms of the heat dissipation ability of the CNT wire 10, preferably the twist count when a strand wire is used is high.

In a metal wire such as a copper wire, a unit lattice serving as a minimum unit forms a grain aggregate and a combination of the unit lattices forms a conductor. In the metal wire, thermal conductivity is obstructed in a radial direction by grain boundaries among grain aggregates, but this makes an insignificant contribution. Thus, in the case of a metal wire, heat dissipation ability is determined mainly by a degree of irregularities on a surface of the metal wire and it is considered that a rough metal wire surface with large irregularities leads to improvements in heat dissipation ability.

On the other hand, the CNT wire 10 is formed by a bunch of CNTs 11a described later, and the CNTs 11a are nanometer-size tubes with a diameter on the order of 1.0 nm to 5.0 nm, with an aspect ratio between diameter and length being on the order of 2000 to 20000. Also, the CNT wire 10 is configured such that the CNTs 11a build up hexagonal close-packed structures, which may be stranded together, thereby forming the CNT wire 10. When electricity is passed through the CNT wire 10, heat is generated in any defective part of each of the CNTs 11a, and thus heat is generated regardless of whether the location is in the center or outer side of the CNTs. In particular, the heat inside the CNTs 11a is not transmitted in a radial direction unless the CNTs 11a are in contact with each other or CNT aggregates 11 are in contact with each other.

Thus, the heat dissipation ability of the CNT wire 10 is determined mainly by balance between a degree of irregularities on a surface of the CNT wire 10 and adhesion among the CNTs 11a or adhesion of the CNT aggregates 11. Thus, with the CNT wire 10 in the form of a strand wire, when arithmetic mean roughness (Ra) of the CNT wire 10 is fixed, the higher the twist count, the more greatly the heat dissipation ability of the CNT wire 10 is considered to improve. Note that in forming a metal wire as a strand wire, it is not possible in terms of mechanical strength and the like to strand the metal wire with a high twist count unlike the CNT wire 10.

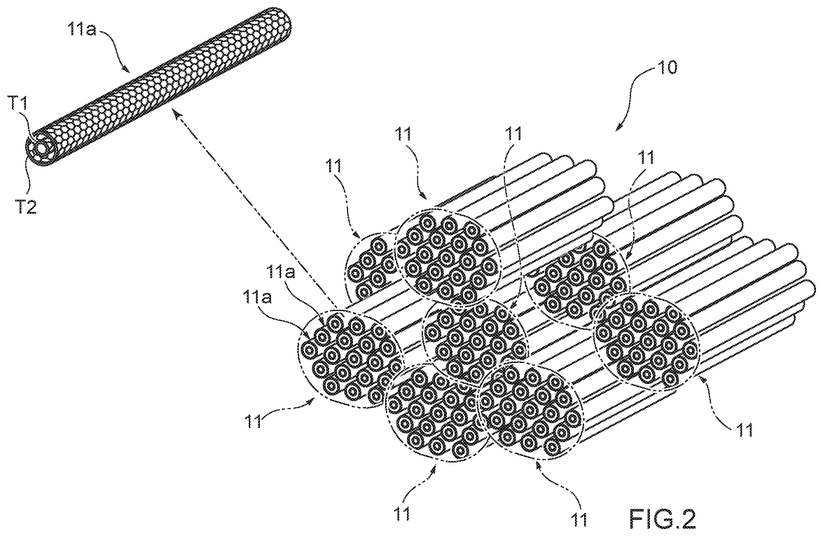

As shown in FIG. 2, the CNT wire 10 is formed by bundling one or more carbon nanotube aggregates (hereinafter sometimes referred to as “CNT aggregates”) 11 each formed by plural CNTs 11a having a layer structure of one or more layers. Here, the CNT wire means a CNT wire in which CNTs make up 90 mass % or more. Note that in calculating the percentage of CNTs in the CNT wire, plating and dopants are excluded. In FIG. 2, the CNT wire 10 has a configuration in which plural CNT aggregates 11 are bundled together. A longitudinal direction of the CNT aggregates 11 corresponds to a longitudinal direction of the CNT wire 10. Thus, the CNT aggregates 11 are linear. The plural CNT aggregates 11 making up the CNT wire 10 are arranged by being almost aligned in a long axis direction. Thus, the plural CNT aggregates 11 in the CNT wire 10 have an orientation.

The CNT wire 10 may be formed with the plural CNT aggregates 11 being stranded together into a bundle. By selecting, as appropriate, a form in which the plural CNT aggregates 11 are bundled, it is possible to adjust the arithmetic mean roughness of the outer surface of the CNT wire 10 in the circumferential direction and longitudinal direction.

Although not specifically limited, the equivalent circle diameter of the CNT wire 10, which is an element wire, is, for example, 0.01 mm to 4.0 mm, both inclusive. Also, although not specifically limited, the equivalent circle diameter of the CNT wire 10, formed as a strand wire, is, for example, 0.1 mm to 15 mm both inclusive.

The CNT aggregate 11 is a bundle of CNTs 11a having a layer structure of one or more layers. A longitudinal direction of the CNTs 11a corresponds to the longitudinal direction of the CNT aggregate 11. The plural CNTs 11a making up the CNT aggregate 11 are arranged by being almost aligned in a long axis direction. Thus, the plural CNTs 11a in the CNT aggregate 11 have an orientation. An equivalent circle diameter of the CNT aggregate 11 is, for example, 20 nm to 1000 nm, both inclusive, and more typically 20 nm to 80 nm, both inclusive. A width dimension of an outermost layer of the CNT 11a is, for example, 1.0 nm to 5.0 nm, both inclusive.

The CNTs 11a forming the CNT aggregate 11 have a tubular body with a single-walled structure or double-walled structure, where the CNT with a single-walled structure and CNT with a double-walled structure are referred to as a SWNT (single-walled nanotube) and MWNT (multi-walled nanotube), respectively. Although only CNTs 11a having a double-walled structure are shown in FIG. 2 for the sake of convenience, the CNT aggregate 11 may contain CNTs 11a having a layer structure of three or more layers and CNTs having a layer structure of a single layer, or may be formed of only CNTs having a layer structure of three or more layers or CNTs having a layer structure of a single layer.

The CNTs 11a having a double-walled structure are called DWNTs (double-walled nanotubes) and are three-dimensional networks in which two tubular bodies T1 and T2 having a hexagonal lattice-like network structure are placed substantially coaxially. A hexagonal lattice, which is a constituent unit, is made up of six-membered rings with carbon atoms placed at the vertices, which are successively bonded to adjacent six-membered rings placed next to one another.

Properties of the CNTs 11a depend on chirality of the tubular bodies. The chirality is broadly classified into an armchair type, zigzag type, and chiral type. The armchair type exhibits metallic behavior, the zigzag type exhibits semiconductive and semi-metallic behavior, and the chiral type exhibits semiconductive and semi-metallic behavior. Thus, electroconductivity of the CNTs 11a varies greatly with which type of chirality the tubular bodies have. In the case of the CNT aggregates 11 forming the CNT wire 10 for the coated CNT electric wire 1, in terms of further improving the electroconductivity, it is preferable to increase the proportion of the armchair type CNTs 11a, which exhibit metallic behavior.

On the other hand, it is known that the chiral type CNTs 11a exhibit metallic behavior if the chiral type CNTs 11a that exhibit semiconductive behavior are doped with a substance (foreign element) having an electron donating property or electron-accepting property. Also, when typical metal is doped with a foreign element, conduction electrons scatter in the metal, reducing electroconductivity, and similarly, doping of CNTs 11a exhibiting metallic behavior with a foreign element causes reduction in electroconductivity.

In this way, from the viewpoint of electroconductivity, since there is a trade-off relation between a doping effect on the CNTs 11a exhibiting metallic behavior and a doping effect on the CNTs 11a exhibiting semiconductive behavior, theoretically it is desirable to separately produce the CNTs 11a exhibiting metallic behavior and the CNTs 11a exhibiting semiconductive behavior, apply a doping process only to the CNTs 11a exhibiting semiconductive behavior, and then combine the two types of CNTs 11a. If the CNTs 11a exhibiting metallic behavior and the CNTs 11a exhibiting semiconductive behavior are produced in a mixed condition, it is preferable to select the layer structure of CNTs 11a that makes doping with a foreign element or molecule effective. This makes it possible to further improve the electroconductivity of the CNT wire 10 made up of a mixture of the CNTs 11a exhibiting metallic behavior and the CNTs 11a exhibiting semiconductive behavior.

For example, CNTs having a small number of layers such as CNTs with a double-walled structure or triple-walled structure is relatively higher in electroconductivity than CNTs having a larger number of layers, and when a doping process is applied, the CNTs having a double-walled structure or triple-walled structure have the highest doping effect. Thus, in terms of further improving the electroconductivity of the CNT wire 10, it is preferable to increase the proportion of CNTs having a double-walled structure or triple-walled structure. Specifically, the proportion of CNTs having a double-walled structure or triple-walled structure to all the CNTs is preferably 50 number % or above, and more preferably 75 number % or above. The proportion of CNTs having a double-walled structure or triple-walled structure can be calculated by observing and analyzing a section of a CNT aggregate 11 using a transmission electron microscope (TEM) and measuring the number of layers of each of 50 to 200 CNTs.

Next, orientations of the CNTs 11a and CNT aggregates 11 in the CNT wire 10 will be described.

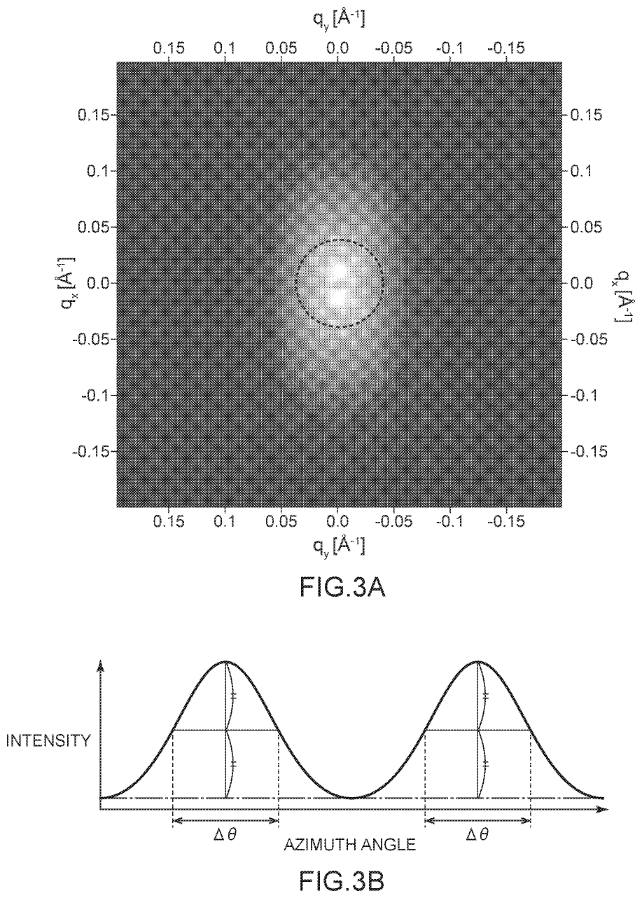

FIG. 3A is diagram showing an example of a two-dimensional scattering image of a scattering vector q of plural CNT aggregates 11 based on small-angle X-ray scattering (SAXS), and FIG. 3B is a graph showing an example of an azimuth plot that represents an azimuth angle versus scattering intensity relationship of an arbitrary scattering vector q whose origin is at the position of a transmitted X-ray in a two-dimensional scattering image.

SAXS is suitable for evaluating a structure and the like a few nm to a few tens of nm in size. For example, by analyzing information about an X-ray scattering image by the following method using SAXS, it is possible to evaluate the orientations of CNTs 11a a few nm in outside diameter and the orientations of CNT aggregates 11 a few tens of nm in outside diameter. For example, when an X-ray scattering image of a CNT wire 10 is analyzed, as shown in FIG. 3A, q_{y}, which is a y component of the scattering vector q (q =2π/d, where d is a lattice spacing) of the CNT aggregate 11, is distributed more narrowly than qₓ, which is an x component. Also, when SAXS azimuth plot of the same CNT wire 10 as in FIG. 3A is analyzed, the full-width at half maximum Δθ in azimuth angle in azimuth plot shown in FIG. 3B is 48 degrees. From these analysis results, it can be said that plural CNTs 11a and plural CNT aggregates 11 have proper orientations in the CNT wire 10. In this way, since plural CNTs 11a and plural CNT aggregates 11 have proper orientations, heat from the CNT wire 10 becomes easy to dissipate by being transmitted smoothly along the longitudinal direction of the CNTs 11a and CNT aggregates 11. Thus, the CNT wire 10, which makes it possible to adjust a heat dissipation route along the longitudinal direction and cross-sectional direction by adjusting the orientations of the CNTs 11a and CNT aggregates 11, exhibits superior heat dissipation characteristics compared to core wires made of metal. Note that the orientations are angular differences of vectors of internal CNTs and CNT aggregates from a longitudinal vector V of a strand wire produced by stranding together CNTs.

Because heat dissipation characteristics of the CNT wire 10 are further improved if an orientation equal to or larger than a predetermined value is obtained, the orientation being represented by the full-width at half maximum Δθ in azimuth angle in the azimuth plot of small-angle X-ray scattering (SAXS), where the full-width at half maximum Δθ represents the orientations of plural CNT aggregates 11, preferably the full-width at half maximum Δθ in azimuth angle is 60 degrees or less, and particularly preferably 50 degrees or less.

Next, an array structure and density of the plural CNTs 11a forming the CNT aggregate 11 will be described.

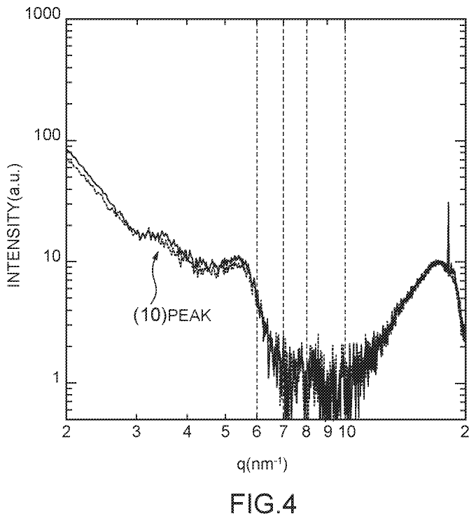

FIG. 4 is a graph showing a q value versus intensity relationship in WAXS (wide-angle X-ray scattering) of the plural CNTs 11a forming a CNT aggregate 11.

WAXS is suitable for evaluating a structure and the like of a substance a few nm or less in size. For example, by analyzing information about an X-ray scattering image by the following method using WAXS, it is possible to evaluate the density of CNTs 11a a few nm or less in outside diameter. When a relationship between the scattering vector q and intensity of an arbitrary CNT aggregate 11 was analyzed, as shown in FIG. 4, a value of a lattice constant estimated from the q value of a peak top at the (10) peak observed in a neighborhood of q=3.0 nm⁻¹ to 4.0 nm⁻¹ is measured. Based on the measured value of the lattice constant and on the diameter of the CNT aggregate observed using Raman spectrometry, TEM, and the like, it can be confirmed that the CNTs 11a form hexagonal close-packed structures in planar view. Thus, it can be said that a diameter distribution of plural CNT aggregates in the CNT wire 10 is narrow and plural CNTs 11a are arranged orderly, i.e., have high density, thereby existing at high density by forming the hexagonal close-packed structures. In this way, since the plural CNT aggregates 11 have proper orientations, and moreover the plural CNTs 11a forming each of the CNT aggregates 11 are arranged orderly and placed at high density, the heat from the CNT wire 10 becomes easy to dissipate by being transmitted smoothly along the longitudinal direction of the CNT aggregates 11. Thus, the CNT wire 10 which makes it possible to adjust the heat dissipation route along the longitudinal direction and cross-sectional direction by adjusting the array structures and densities of the CNT aggregates 11 and CNTs 11a, exhibits superior heat dissipation characteristics compared to core wires made of metal.

Because heat dissipation characteristics are further improved by obtaining high density, preferably the q value of the peak top at the (10) peak of intensity of X-ray scattering that represents the density of the plural CNTs 11a is 2.0 nm⁻¹ to 5.0 nm⁻¹, both inclusive, and the full-width at half maximum Δq (FWHM) is 0.1 nm⁻¹ to 2.0 nm⁻¹, both inclusive.

The orientations of the CNT aggregates 11 and CNTs 11a as well as the array structure and density of the CNTs 11a can be adjusted by appropriately selecting a spinning method such as dry spinning, wet spinning, or liquid crystal spinning described later and spinning conditions of the spinning method.

Next, the insulating coating layer 21 configured to coat an external surface of the CNT wire 10 will be described.

As a material for the insulating coating layer 21, a material used for the insulating coating layer of the coated electric wire for which metal is used as the core wire can be used. Examples of materials available for use include thermoplastic resins and thermosetting resins. Examples of the thermoplastic resins include polytetrafluoroethylene (PTFE), polyethylene, polypropylene, polyacetal, polystyrene, polycarbonate, polyamide, polyvinyl chloride, polyvinyl acetate, polyurethane, polymethyl methacrylate, acrylonitrile butadiene styrene resins, and acrylic resins. Examples of the thermosetting resins include polyimide and phenolic resins. These resins may be used alone or in an appropriate combination of two or more.

The insulating coating layer 21 may be single-layered as shown in FIG. 1, or multi-layered alternatively. Also, a layer of a thermosetting resin may be further provided between the external surface of the CNT wire 10 and insulating coating layer 21 as needed.

With the coated CNT electric wire 1, because the core wire is the CNT wire 10 lighter than copper, aluminum, and the like, and the insulating coating layer 21 can be reduced in thickness, the electric wire coated with the insulating coating layer can be reduced in weight and superior heat dissipation characteristics against the heat from the CNT wire 10 can be obtained without impairing insulation reliability.

Also, the coated CNT electric wire 1 has any of an aspect in which the arithmetic mean roughness (Ra1) of the outer surface of the CNT wire 10 in the circumferential direction is larger than the arithmetic mean roughness (Ra2) of an outer surface of the insulating coating layer 21 in the circumferential direction, an aspect in which the arithmetic mean roughness (Ra3) of the outer surface of the CNT wire 10 in the longitudinal direction is larger than the arithmetic mean roughness (Ra4) of the outer surface of the insulating coating layer 21 in the longitudinal direction, and an aspect in which the arithmetic mean roughness (Ra1) of the outer surface of the CNT wire 10 in the circumferential direction is larger than the arithmetic mean roughness (Ra2) of the outer surface of the insulating coating layer 21 in the circumferential direction and the arithmetic mean roughness (Ra3) of the outer surface of the CNT wire 10 in the longitudinal direction is larger than the arithmetic mean roughness (Ra4) of the outer surface of the insulating coating layer 21 in the longitudinal direction.

Since the arithmetic mean roughness (Ra) of the outer surface of the CNT wire 10 is larger than the arithmetic mean roughness (Ra) of the outer surface of the insulating coating layer 21, adhesiveness between the insulating coating layer 21 and CNT wire 10 improves, preventing the insulating coating layer 21 from separating from the CNT wire 10, and thereby making it possible to maintain good insulation property of the coated CNT electric wire 1 for an extended period of time. Also, since the arithmetic mean roughness (Ra) of the outer surface of the insulating coating layer 21 is smaller than the arithmetic mean roughness (Ra) of the outer surface of the CNT wire 10, heat dissipation ability improves.

When the arithmetic mean roughness (Ra1) of the outer surface of the CNT wire 10 in the circumferential direction is larger in value than the arithmetic mean roughness (Ra2) of the outer surface of the insulating coating layer 21 in the circumferential direction, in terms of preventing partial discharge of the CNT wire 10 while further improving the adhesiveness and heat dissipation ability between the insulating coating layer 21 and CNT wire 10 in the circumferential direction, preferably the arithmetic mean roughness (Ra1) of the outer surface of the CNT wire 10 in the circumferential direction is 8.0 μm to 60.0 μm, both inclusive, and particularly preferably 30.0 μm to 56.0 μm, both inclusive. The value of the arithmetic mean roughness (Ra2) of the outer surface of the insulating coating layer 21 in the circumferential direction is not specifically limited as long as the value is smaller than the arithmetic mean roughness (Ra1) of the outer surface of the CNT wire 10 in the circumferential direction, but in terms of further improving the adhesiveness and heat dissipation ability in the circumferential direction, preferably the value is 15.0 μm or less, more preferably 12.0 μm or less, and particularly preferably 6.0 μm to 12.0 μm, both inclusive.

Also, in the above aspect, the value of the arithmetic mean roughness (Ra1) of the outer surface of the CNT wire 10 in the circumferential direction/the arithmetic mean roughness (Ra2) of the outer surface of the insulating coating layer 21 in the circumferential direction is larger than 1.0, and preferably 1.3 to 10.0, and particularly preferably 3.0 to 9.0.

Also, when the arithmetic mean roughness (Ra3) of the outer surface of the CNT wire 10 in the longitudinal direction is larger in value than the arithmetic mean roughness (Ra4) of the outer surface of the insulating coating layer 21 in the longitudinal direction, in terms of preventing partial discharge of the CNT wire 10 while further improving the adhesiveness and heat dissipation ability between the insulating coating layer 21 and CNT wire 10 in the longitudinal direction, preferably the arithmetic mean roughness (Ra3) of the outer surface of the CNT wire 10 in the longitudinal direction is 8.0 μm to 45.0 μm, both inclusive, and particularly preferably 25.0 μm to 43.0 μm, both inclusive. Also, the value of the arithmetic mean roughness (Ra4) of the outer surface of the insulating coating layer 21 in the longitudinal direction is not specifically limited as long as the value is smaller than the arithmetic mean roughness (Ra3) of the outer surface of the CNT wire 10 in the longitudinal direction, but in terms of further improving durability of the insulating coating in the longitudinal direction, preferably the value is 15.0 μm or less, and particularly preferably 5.0 μm to 10.0 μm, both inclusive.

Also, in the above aspect, the value of the arithmetic mean roughness (Ra3) of the outer surface of the CNT wire 10 in the longitudinal direction/the arithmetic mean roughness (Ra4) of the outer surface of the insulating coating layer 21 in the longitudinal direction is larger than 1.0, and preferably 1.4 to 10.0, and particularly preferably 2.0 to 5.0.

Both the arithmetic mean roughness in the circumferential direction and arithmetic mean roughness in the longitudinal direction described above are values measured by a non-contact surface roughness tester. The arithmetic mean roughness in the circumferential direction is a mean value of values measured at 10 spots at 10 cm intervals in the longitudinal direction in an arbitrary site of the coated CNT electric wire 1. Also, a measuring area for the arithmetic mean roughness of the coated CNT electric wire 1 in the longitudinal direction is an arbitrary area of the entire coated CNT electric wire 1, where the arbitrary area has a length of 100 cm.

By adjusting the resin type of material of the insulating coating layer 21 as well as extrusion conditions if the insulating coating layer 21 is formed on the peripheral surface of the CNT wire 10 by extrusion coating, it is possible to adjust the arithmetic mean roughness of the outer surface of the insulating coating layer 21 in the circumferential direction and longitudinal direction.

Also, a metal layer may be provided between the CNT wire 10 and insulating coating layer 21. If the metal layer is provided, the insulating coating layer 21 of the coated CNT electric wire 1 is in the form of being not in contact with the peripheral surface of the CNT wire 10. The metal layer may be formed on all or part of the outer surface of the CNT wire 10.

Since the metal layer is provided between the CNT wire 10 and insulating coating layer 21, it is possible to adjust the arithmetic mean roughness of the outer surface of the insulating coating layer 21 in the circumferential direction and longitudinal direction and thereby make values of the arithmetic mean roughness uniform. Thus, abrasion resistance improves more uniformly over the entire insulating coating layer 21.

Examples of the metal layer include a metal-plated layer formed by plating an outer surface of the CNT wire 10 in the longitudinal direction. Examples of the plating include, but are not specifically limited to, solder plating, copper plating, nickel plating, nickel-zinc alloy plating, palladium plating, cobalt plating, tin plating, and silver plating. The metal-plated layer may be either single-layered or multi-layered.

Next, an exemplary production method of the coated CNT electric wire 1 according to the exemplary embodiment of the present disclosure will be described. The coated CNT electric wire 1 can be produced by producing the CNTs 11a first, forming the CNT wire 10 from the obtained plural CNTs 11a, and then coating the peripheral surface of the CNT wire 10 with the insulating coating layer 21.

The CNTs 11a can be produced by a technique such as a floating catalyst method (Japanese Patent No. 5819888) or substrate method (Japanese Patent No. 5590603). An element wires of the CNT wire 10 can be produced by dry spinning (Japanese Patent Nos. 5819888, 5990202, and 5350635), wet spinning (Japanese Patent Nos. 5135620, 5131571, 5288359), or liquid crystal spinning (Japanese Translation of PCT International Application Publication No. 2014-530964).

As a method for coating the peripheral surface of the CNT wire 10 obtained as described above with the insulating coating layer 21, a method for coating a core wire of aluminum or copper with an insulating coating layer is available for use, and examples include a method for melting a thermoplastic resin, which is a raw material for the insulating coating layer 21, and extruding the thermoplastic resin around the CNT wire 10 to coat the CNT wire 10.

The coated CNT electric wire 1 according to the exemplary embodiment of the present disclosure can be used as general wires such as wire harnesses. Also, cables may be produced from general wires that use the coated CNT electric wire 1.

### EXAMPLES

Next, examples of the present disclosure will be described, but the present disclosure is not limited to the following examples insofar as it does not depart from the spirit of the present disclosure.

### Examples 1 to 32 and Comparative Examples 1 to 8

### About Production Method of CNT Wire

First, a strand wire made up of plural CNT wires with an equivalent circle diameter of 5 mm was obtained using a dry spinning method (Japanese Patent No. 5819888) or wet spinning method (Japanese Patent Nos. 5135620, 5131571, 5288359) used to directly spin CNTs produced by a floating catalyst method.

### About Method for Coating Outer Surface of CNT Wire with Insulating Coating Layer

Using the resins listed in Table 1 below, an insulating coating layer 2.3 mm in average thickness was formed on the outer surface of the CNT wire along the longitudinal direction by extrusion coating to produce the coated CNT electric wires to be used in the examples and comparative examples shown in Table 1 below.

Measurement of arithmetic mean roughness (Ra1) of outer surface of CNT wire in circumferential direction, measurement of arithmetic mean roughness (Ra2) of outer surface of insulating coating layer in circumferential direction, measurement of arithmetic mean roughness (Ra3) of outer surface of CNT wire in longitudinal direction, and measurement of arithmetic mean roughness (Ra4) of outer surface of insulating coating layer in longitudinal direction

Ra1 to Ra4 were all measured by the following three methods.

Surface irregularities were found using an atomic force microscope and values of Ra<0.01 μm were calculated from the surface irregularities.

Surface shapes of the CNT wire and insulating coating layer were found using a scanning electron microscope incorporating plural detectors. Values of 0.01≤Ra≤1.00 μm were calculated from the surface shapes.

Surface shapes were found using a laser microscope and values of 1.00≤Ra≤100 μm were calculated from the surface shapes.

Results of the measurements of the coated CNT electric wires are shown in Table 1 below.

The following evaluations were made of the coated CNT electric wires produced as described above.

### (1) Measurement of Twist Count of CNT Wire

Regarding a strand wire, plural solid wires were bundled together, and with one end fixed, another end was twisted predetermined times to form the strand wire. The twist count was expressed by a value (unit: T/m) obtained by dividing the number of times (T) the wires were twisted by the length (m) of the wires.

### (2) Adhesiveness

The coated CNT electric wire was held by a mandrel with a diameter of 12 mm and bent 90 degrees each to the left and right (for a total of 180 degrees) with a weight of 1 kg hung from the coated CNT electric wire.

After a 100,000-cycle bending test, if no separation of the insulating coating layer from CNT wire was observed, Good was given, if some separation was observed, Fair was given, and if separation was observed, Poor was given.

### (3) Heat Dissipation Ability in Circumferential Direction

As an evaluation method for heat dissipation ability in the circumferential direction, a laser flash method was adopted. The coated CNT electric wire was embedded in resin, and was ground until a side face of the coated CNT electric wire was exposed to a surface. The sample subjected to grinding was irradiated with laser pulse light, the temperature of another surface was measured by an infrared sensor, and time variation of the temperature was measured.

### (4) Heat Dissipation Ability Attributable to Twisting

As an evaluation method for heat dissipation ability attributable to twisting, the laser flash method was adopted. A bare CNT electric wire was embedded in resin, and was ground until a side face of the bare CNT electric wire was exposed to a surface. The sample subjected to grinding was irradiated with laser pulse light, the temperature of another surface was measured by an infrared sensor, and time variation of the temperature was measured.

### (5) Heat Dissipation Ability of Coated CNT Electric Wire

By connecting four terminals to opposite ends of a 100-cm coated CNT electric wire, resistance was measured by a four-terminal method. In so doing, an applied current was set to be 2,000 A/cm², and time variation of resistance value was measured. The resistance value at a measurement start time and the resistance value upon elapse of 10 minutes were compared and the rate of resistance increase was measured. Because the CNT electric wire increases in resistance in proportion to temperature, it can be determined that the smaller the rate of resistance increase, the higher the heat dissipation ability. If the rate of resistance increase was less than 10%, Excellent was given, if the rate of resistance increase was from 10% (inclusive) to 13% (exclusive), Good was given, if the rate of resistance increase was from 13% (inclusive) to 15% (exclusive), Fair was given, and if the rate of resistance increase was 15% or above, Poor was given.

Results of the evaluations described above are shown in Table 1 below.

TABLE 1

| | | | | Insulating | | | | | heat dissipation | Heat dissipation | Heat dissipation |
|---|---|---|---|---|---|---|---|---|---|---|---|
| | Resin type of | CNT wire | | coating layer | | Twist count | Degree of | | ability | ability | ability |
| | insulating | Ra1 | Ra3 | Ra2 | Ra4 | of CNT | twist of | | in radial | attributable | of coated CNT |
| | coating layer | (μm) | (μm) | (μm) | (μm) | wire (T/m) | CNT wire | Adhesiveness | direction | to twisting | electric wire |
| Example 1 | Polypropylene | 55.20 | 42 00 | 6.20 | 9.60 | 2900 | Very tight | Good | Good | Excellent | Excellent |
| Example 2 | | 40.20 | 30.00 | 12.00 | 6.34 | 5030 | Very tight | Good | Good | Excellent | Excellent |
| Example 3 | | 15.02 | 10.20 | 8.80 | 9.23 | 9000 | Very tight | Fair | Fair | Excellent | Good |
| Example 4 | | 8.30 | 8.00 | 6.90 | 6.43 | 11200 | Very tight | Fair | Fair | Excellent | Good |
| Example 5 | | 51.50 | 13.20 | 6.20 | 13.10 | 1930 | Tight | Fair | Fair | Good | Fair |
| Example 6 | | 38.30 | 11.68 | 11.50 | 11.40 | 1780 | Tight | Fair | Fair | Good | Fair |
| Example 7 | | 59.10 | 41.23 | 11.65 | 14.32 | 100 | Loose | Good | Good | Poor | Fair |
| Example 8 | | 52.10 | 37.43 | 10.31 | 12.04 | 450 | Loose | Good | Good | Poor | Fair |
| Example 9 | | 46.32 | 33.15 | 12.00 | 7.38 | 650 | Gentle | Good | Good | Fair | Good |
| Example 10 | | 42.69 | 29.57 | 7.35 | 11.03 | 800 | Gentle | Good | Good | Fair | Good |
| Example 11 | | 35.32 | 26.15 | 6.44 | 8.55 | 1304 | Tight | Good | Good | Good | Excellent |
| Example 12 | | 29.12 | 21.54 | 9.00 | 10.43 | 1600 | Tight | Good | Good | Good | Excellent |
| Example 13 | | 23.44 | 18.55 | 11.30 | 14.45 | 1890 | Tight | Fair | Fair | Excellent | Good |
| Example 14 | | 18.40 | 16.56 | 12.00 | 11.23 | 10230 | Very tight | Fair | Fair | Excellent | Good |
| Example 15 | | 12.94 | 13.04 | 7.40 | 7.98 | 1930 | Tight | Fair | Fair | Good | Fair |
| Example 16 | | 10.33 | 11.20 | 8.34 | 8.83 | 14000 | Very tight | Fair | Fair | Good | Fair |
| Example 17 | Polystyrene | 55.20 | 42.00 | 6.20 | 9.60 | 2900 | Very tight | Good | Good | Excellent | Excellent |
| Example 18 | | 40.20 | 30.00 | 12.00 | 6.34 | 5030 | Very tight | Good | Good | Excellent | Excellent |
| Example 19 | | 15.02 | 10.20 | 8.80 | 9.23 | 9000 | Very tight | Fair | Fair | Excellent | Good |
| Example 20 | | 8.30 | 8.00 | 6.90 | 6.43 | 11200 | Very tight | Fair | Fair | Excellent | Good |
| Example 21 | | 51.60 | 13.20 | 6.20 | 13.10 | 1930 | Tight | Fair | Fair | Good | Fair |
| Example 22 | | 38.30 | 11.68 | 11.50 | 11.40 | 1780 | Tight | Fair | Fair | Good | Fair |
| Example 23 | | 59.10 | 41.23 | 11.65 | 14.32 | 100 | Loose | Good | Good | Poor | Fair |
| Example 24 | | 52.10 | 37.43 | 10.31 | 12.04 | 450 | Loose | Good | Good | Poor | Fair |
| Example 25 | | 46.32 | 33.15 | 12.00 | 7.38 | 650 | Gentle | Good | Good | Fair | Good |
| Example 26 | | 42.69 | 29.57 | 7.35 | 11.03 | 800 | Gentle | Good | Good | Fair | Good |
| Example 27 | | 35.32 | 26.15 | 6.44 | 8.55 | 1304 | Tight | Good | Good | Good | Excellent |
| Example 28 | | 29.12 | 21.54 | 9.00 | 10.43 | 1600 | Tight | Good | Good | Good | Excellent |
| Example 29 | | 23.44 | 18.55 | 11.30 | 14.45 | 1890 | Tight | Fair | Fair | Excellent | Good |
| Example 30 | | 18.40 | 16.56 | 12.00 | 11.23 | 10230 | Very tight | Fair | Fair | Excellent | Good |
| Example 31 | | 12.94 | 13.04 | 7.40 | 7.98 | 1930 | Tight | Fair | Fair | Good | Fair |
| Example 32 | | 10.33 | 11.20 | 8.34 | 8.83 | 14000 | Very tight | Fair | Fair | Good | Fair |
| Comparative | Polypropylene | 1.30 | 0.03 | 8.30 | 6.70 | 120 | Loose | Poor | Poor | Poor | Poor |
| Example 1 | | | | | | | | | | | |
| Comparative | | 0.70 | 0.01 | 10.50 | 9.50 | 760 | Gentle | Poor | Poor | Fair | Poor |
| Example 2 | | | | | | | | | | | |
| Comparative | | 5.63 | 5.67 | 8.56 | 7.34 | 1505 | Tight | Poor | Poor | Good | Poor |
| Example 3 | | | | | | | | | | | |
| Comparative | | 7.32 | 6.89 | 11.34 | 10.22 | 9804 | Very tight | Poor | Poor | Excellent | Poor |
| Example 4 | | | | | | | | | | | |
| Comparative | Polystyrene | 1.30 | 0.03 | 8.30 | 6.70 | 120 | Loose | Poor | Poor | Poor | Poor |
| Example 5 | | | | | | | | | | | |
| Comparative | | 0.70 | 0.01 | 10.50 | 9.50 | 760 | Gentle | Poor | Poor | Fair | Poor |
| Example 6 | | | | | | | | | | | |
| Comparative | | 5.63 | 5.67 | 8.56 | 7.34 | 1505 | Tight | Poor | Poor | Good | Poor |
| Example 7 | | | | | | | | | | | |
| Comparative | | 7.32 | 6.89 | 11.34 | 10.22 | 9804 | Very tight | Poor | Poor | Excellent | Poor |
| Example 8 | | | | | | | | | | | |

As shown in Table 1 above, because the arithmetic mean roughness (Ra1) of the outer surface of the CNT wire in the circumferential direction was larger than the arithmetic mean roughness (Ra2) of the outer surface of the insulating coating layer in the circumferential direction and/or the arithmetic mean roughness (Ra3) of the outer surface of the CNT wire in the longitudinal direction was larger than the arithmetic mean roughness (Ra4) of the outer surface of the insulating coating layer in the longitudinal direction, Examples 1 to 32 excelled in the adhesive strength between the CNT wire and insulating coating layer as well as in the adhesiveness of the insulating coating layer and provided excellent heat dissipation ability in the longitudinal direction, regardless of the resin type of the insulating coating layer. Also, all Examples 1 to 32 provided excellent heat dissipation ability in the circumferential direction.

Also, because the arithmetic mean roughness (Ra1) of the outer surface of the CNT wire in the circumferential direction was larger than the arithmetic mean roughness (Ra2) of the outer surface of the insulating coating layer in the circumferential direction and the arithmetic mean roughness (Ra3) of the outer surface of the CNT wire in the longitudinal direction was larger than the arithmetic mean roughness (Ra4) of the outer surface of the insulating coating layer in the longitudinal direction, Examples 1 to 4, 7 to 20, and 23 to 32 more reliably improved the adhesive strength between the CNT wire and insulating coating layer as well as the adhesiveness of the insulating coating layer and more reliably provided excellent heat dissipation ability in the longitudinal direction, regardless of the resin type of the insulating coating layer.

Also, the examples in which the twist count was 650 T/m to 14000 T/m not only had better heat dissipation ability in the circumferential direction but also had better heat dissipation ability attributable to twisting than Examples 7, 8, 21, and 22 in which the twist count of the CNT wire was 100 T/m to 450 T/m. Thus, it was found that increasing the twist count of the CNT wire contributes to further improvement of heat dissipation ability in the longitudinal direction. In particular, the heat dissipation ability attributable to twisting improved with increases in the twist count of the CNT wire, consequently contributing to the improvement of the heat dissipation ability in the longitudinal direction.

On the other hand, Comparative Examples 1 to 8, in which the arithmetic mean roughness (Ra2) of the outer surface of the insulating coating layer in the circumferential direction was larger than the arithmetic mean roughness (Ra1) of the outer surface of the CNT wire in the circumferential direction and the arithmetic mean roughness (Ra4) of the outer surface of the insulating coating layer in the longitudinal direction was larger than the arithmetic mean roughness (Ra3) of the outer surface of the CNT wire in the longitudinal direction was not able to satisfy both adhesiveness and heat dissipation ability in the longitudinal direction.

Also, Comparative Examples 3, 4, 7, and 8, in which the degree of twist was increased to 1505 T/m to 9804 T/m, did not provide proper heat dissipation ability of the coated CNT electric wire even though the heat dissipation ability attributable to twisting improved. It is considered that this is because the arithmetic mean roughness (Ra1) of the outer surface of the CNT wire in the circumferential direction and the arithmetic mean roughness (Ra3) of the outer surface of the CNT wire in the longitudinal direction are low, making the heat dissipation ability in the circumferential direction low.

1. A coated carbon nanotube electric wire comprising: a carbon nanotube wire made up of one or more carbon nanotube aggregates formed by a plurality of carbon nanotubes; and an insulating coating layer configured to coat the carbon nanotube wire, wherein
arithmetic mean roughness (Ra1) of an outer surface of the carbon nanotube wire in a circumferential direction is larger than arithmetic mean roughness (Ra2) of an outer surface of the insulating coating layer in the circumferential direction.

2. A coated carbon nanotube electric wire comprising: a carbon nanotube wire made up of one or more carbon nanotube aggregates formed by a plurality of carbon nanotubes; and an insulating coating layer configured to coat the carbon nanotube wire, wherein
arithmetic mean roughness (Ra3) of an outer surface of the carbon nanotube wire in a longitudinal direction is larger than arithmetic mean roughness (Ra4) of an outer surface of the insulating coating layer in the longitudinal direction.

3. A coated carbon nanotube electric wire comprising: a carbon nanotube wire made up of one or more carbon nanotube aggregates formed by a plurality of carbon nanotubes; and an insulating coating layer configured to coat the carbon nanotube wire, wherein
arithmetic mean roughness (Ra1) of an outer surface of the carbon nanotube wire in a circumferential direction is larger than arithmetic mean roughness (Ra2) of an outer surface of the insulating coating layer in the circumferential direction, and arithmetic mean roughness (Ra3) of an outer surface of the carbon nanotube wire in a longitudinal direction is larger than arithmetic mean roughness (Ra4) of an outer surface of the insulating coating layer in the longitudinal direction.

4. The coated carbon nanotube electric wire according to claim 1, wherein the carbon nanotube wire is formed by stranding together a plurality of the carbon nanotube aggregates.

5. The coated carbon nanotube electric wire according to claim 4, wherein a twist count of the carbon nanotube wire formed by stranding is 100 T/m to 14000 T/m, both inclusive.

6. The coated carbon nanotube electric wire according to claim 4, wherein a twist count of the carbon nanotube wire formed by stranding is 500 T/m to 14000 T/m, both inclusive.

7. The coated carbon nanotube electric wire according to claim 4, wherein a twist count of the carbon nanotube wire formed by stranding is 1000 T/m to 14000 T/m, both inclusive.

8. The coated carbon nanotube electric wire according to claim 4, wherein a twist count of the carbon nanotube wire formed by stranding is 2500 T/m to 14000 T/m, both inclusive.

9. The coated carbon nanotube electric wire according to claim 1, wherein at least part of the insulating coating layer is in contact with the carbon nanotube wire.

10. The coated carbon nanotube electric wire according to claim 1, wherein arithmetic mean roughness (Ra1) of an outer surface of the carbon nanotube wire in a circumferential direction is 8.0 μm to 60.0 μm, both inclusive, and arithmetic mean roughness (Ra2) of an outer surface of the insulating coating layer in the circumferential direction is 12.0 μm or less.

11. The coated carbon nanotube electric wire according to claim 1, wherein arithmetic mean roughness (Ra3) of an outer surface of the carbon nanotube wire in a longitudinal direction is 8.0 μm to 45.0 μm, both inclusive, and arithmetic mean roughness (Ra4) of an outer surface of the insulating coating layer in the longitudinal direction is 15.0 μm or less.

12. The coated carbon nanotube electric wire according to claim 1, wherein a metal layer is provided between the carbon nanotube wire and the insulating coating layer.

13. The coated carbon nanotube electric wire according to claim 1, wherein the carbon nanotube wire is made up of a plurality of the carbon nanotube aggregates, and a full-width at half maximum Δθ in azimuth angle in azimuth plot of small-angle X-ray scattering is 60 degrees or less, the small-angle X-ray scattering representing orientations of the plurality of carbon nanotube aggregates.

14. The coated carbon nanotube electric wire according to claim 1, wherein a q value of a peak top at a (10) peak of scattering intensity of X-ray scattering representing density of a plurality of the carbon nanotubes is 2.0 nm⁻¹ to 5.0 nm⁻¹, both inclusive, and a full-width at half maximum Δq is 0.1 nm⁻¹ to 2.0 nm⁻¹.

15. A wire harness using the coated carbon nanotube electric wire according to claim 1.

16. The coated carbon nanotube electric wire according to claim 2, wherein the carbon nanotube wire is formed by stranding together a plurality of the carbon nanotube aggregates.

17. The coated carbon nanotube electric wire according to claim 3, wherein the carbon nanotube wire is formed by stranding together a plurality of the carbon nanotube aggregates.

18. The coated carbon nanotube electric wire according to claim 2, wherein at least part of the insulating coating layer is in contact with the carbon nanotube wire.

19. The coated carbon nanotube electric wire according to claim 3, wherein at least part of the insulating coating layer is in contact with the carbon nanotube wire.

20. The coated carbon nanotube electric wire according to claim 2, wherein arithmetic mean roughness (Ra1) of an outer surface of the carbon nanotube wire in a circumferential direction is 8.0 μm to 60.0 μm, both inclusive, and arithmetic mean roughness (Ra2) of an outer surface of the insulating coating layer in the circumferential direction is 12.0 μm or less.
